(19) United States
(12) Patent Application Publication
(10) Pub. No.: US 2017/0210198 A1
(43) Pub. Date: Jul. 27, 2017

(54) AIR CONDITIONING UNIT

(71) Applicant: Mahle International GmbH, Stuttgart (DE)

(72) Inventors: Erik Person, Stuttgart (DE); Norman Schaake, Markgroeningen (DE)

(21) Appl. No.: 15/414,586

(22) Filed: Jan. 24, 2017

(30) Foreign Application Priority Data
Jan. 25, 2016 (DE) 10 2016 200 999.0

(51) Int. Cl. B60H 1/00; B60H 3/06; B60H 1/26

(52) U.S. Cl. CPC B60H 1/00564; B60H 1/26; B60H 3/06; B60H 2001/006

(57) ABSTRACT

An air conditioning unit for a motor vehicle may include a housing having a fan arranged within the housing for generating an air flow and at least one housing region through which the air flow can flow. The housing may also include an outer wall separating a surrounding region of the housing from an interior of the respective housing region, the air flow being flowable through the interior. The outer wall may have at least wall section, the outer wall having a wall thickness in the wall section that is smaller than a wall thickness of the outer wall outside the wall section. An airborne sound absorber may be arranged on an outer side of the outer wall in a region of the wall section, the outer side of the outer wall facing away from the interior.

### CROSS-REFERENCE TO RELATED APPLICATIONS

This application claims priority to German Patent Application No. 10 2016 200 999.0, filed Jan. 25, 2016, the contents of which are hereby incorporated by reference in its entirety.

### TECHNICAL FIELD

The present invention relates to an air conditioning unit for a motor vehicle.

### BACKGROUND

An air conditioning unit of the generic type is known, for example, from U.S. Pat. No. 6,178,764 B1. It comprises a housing, in which a fan for generating an air flow is arranged, and which housing has at least one housing region, through which the air flow can flow, an outer wall of the housing separating a surrounding region of the housing from an interior of the respective housing region, through which interior the air flow can flow.

An air conditioning unit of this type generates noise during operation, which noise exits into the surrounding region in the form of airborne sound. Firstly, the fan generates noise by way of its electric motor drive and by way of its fan impeller. Secondly, the air flow itself can also generate noise within the housing. In the case of vehicles with an internal combustion engine, the noise emission of the air conditioning unit is as a rule negligible when the internal combustion engine is switched on, since the noise emission of the internal combustion engine is considerably more pronounced than the noise emission of the air conditioning unit. However, modern vehicles with an internal combustion engine are frequently equipped with a start/stop automatic system which ensures that the internal combustion engine is switched off when the vehicle is at a standstill, if the current operating state permits this. When the internal combustion engine is switched off, however, the noise of the air conditioning unit is perceptible in the vehicle interior. The noise of the air conditioning unit is also perceptible during an electric operation state in the case of vehicles with an electric motor drive. There is therefore the requirement to reduce the noise emission of the air conditioning unit.

In the case of U.S. Pat. No. 6,178,764 A1 which was mentioned above, window-like openings are made in the outer wall of the housing, which openings penetrate the outer wall. Airborne sound absorbers are attached on an outer side of the outer wall which faces away from the interior, which airborne sound absorbers close the openings of the outer wall. Therefore, airborne sound can enter from the interior through the openings into the respective airborne sound absorber, as a result of which efficient noise damping is achieved. It is a problem here that there is the risk of leakage through the openings, with the result that either air which is unfiltered on the suction side of the fan is sucked into the interior from the surrounding area or, on the pressure side of the fan, air from the interior can exit into the surrounding area and is not available for climate control of a vehicle interior compartment. Furthermore, the openings in the outer wall form disruptive contours which increase the flow resistance of the air flow in the housing and for their part can be a source for noise development.

DE 10 2006 057 823 A1 has disclosed configuring a receptacle in the outer wall of the housing on an inner side of the outer wall which faces the interior, into which receptacle an absorber material is inserted, and which receptacle is covered towards the interior with a gas-permeable covering. The outlay for realising noise damping of this type is comparatively great. Firstly, there is a significant intervention in the design of the outer wall, in order for it to be possible to configure the respective receptacle. Secondly, assembly is made more difficult, since the respective receptacle has to be filled with the absorber material from the interior and has to be closed by way of the covering. In particular, as a result, housing regions, in which substantial noise emission takes place, cannot be equipped by means of a receptacle of this type if it are not accessible from the interior.

DE 102 60 932 A1 has disclosed making a window-like opening in the outer wall of the housing, which opening penetrates the outer wall. A sound-absorbing element is inserted into the said opening. There is also the risk again here of leaks and of impairments of the air flow which increase the flow resistance and for their part can generate noise in the case of an unfavourable incident flow.

### SUMMARY

The present invention is concerned with the problem of specifying an improved embodiment for an air conditioning unit of the type described at the outset, which embodiment is distinguished, in particular, by reduced noise emission, without the flow resistance for the air flow being increased and/or the production of the air conditioning unit being made more difficult as a result.

According to the invention, the said problem is solved by way of the subject matter of the independent claims. Advantageous embodiments are the subject matter of the dependent claims.

The invention is based on the general concept of providing the outer wall of the housing with at least one thin-walled wall section and of arranging an airborne sound absorber on the outer side of the outer wall in the region of the said thin-walled wall section. The thin-walled wall section has a lower rigidity than adjoining wall sections with a greater wall thickness. As a consequence, the thin-walled wall section can be excited to perform vibrations more readily. Therefore, the thin-walled wall section forms a region within the outer wall, which region can preferably transmit airborne sound from the interior to the surrounding area, and which region can preferably emit solid-borne sound which propagates within the housing as airborne sound into the surrounding area. By way of the arrangement of the airborne sound absorber on the outer side of the outer wall in a targeted manner in the said thin-walled section, damping of the airborne sound can therefore be carried out efficiently, which reduces the noise emission of the air conditioning unit into the surrounding area. The arrangement of the airborne sound absorber on the outer side of the outer wall facilitates assembly. The respective thin-walled wall section can be realised within the outer wall particularly simply in such a way that no leaks are produced and/or no unnecessary flow obstacles are formed as a result. Therefore, efficient noise damping can be achieved with low manufacturing outlay, without the risk of leaks being produced and/or the flow resistance being increased as a result.

In the thin-walled wall section, a wall thickness of the outer wall is smaller than a wall thickness which the outer wall outside the thin-walled wall section has. At least in a wall section which adjoins the respective thin-walled wall section, the outer wall has a wall thickness which is greater than the wall thickness in the thin-walled wall section.

According to one particularly advantageous embodiment, the outer wall can be of continuous configuration in an outer wall region which contains the thin-walled wall section, with the result that the outer wall has, as it were, a constant or continuous profile in the said outer wall region. In particular, the outer wall has no interruption or opening or step in the said outer wall region.

The outer wall can expediently be of continuous configuration in an outer wall region which comprises the thin-walled wall section on an inner side of the outer wall which faces the interior. This means that it cannot be seen using the contour which the outer wall region has on the inner side where the thin-walled wall section is situated within the outer wall region. In the said outer wall region, the outer wall therefore has a homogeneous, constant, that is to say continuous contour on the inner side over the thin-walled wall section. By way of the said design, the thin-walled wall section has no additional, disadvantageous influence on the flow resistance of the air flow in the interior.

The thin-walled wall section can expediently be formed by way of a depression in the outer wall, which depression is configured only on the outer side of the outer wall. As a result, the abovementioned continuous configuration of the outer wall and the continuous inner side of the outer wall and the construction from one material can be realised particularly simply.

The thin-walled wall section is expediently formed integrally at least in one adjoining region of the outer wall, such that a configuration from one material results in an outer wall region which contains the thin-walled wall section. The continuous configuration of the outer wall region therefore also entails that the thin-walled wall section is not a separate component, but rather is formed integrally in the outer wall region. The thin-walled wall section is preferably configured from one material in the outer wall region. For example, the housing is a single-piece or multiple-piece injection moulded part which is manufactured, for example, from plastic. The outer wall region is then manufactured with the thin-walled wall section from the same material and preferably during the same injection moulding operation.

According to one advantageous development, the airborne sound absorber can fill the depression. As a result, the space which is provided by way of the depression on the outer side of the outer wall can also be utilized to accommodate absorber material, with the result that more absorber material is available overall.

In one alternative development, the depression can form a cavity which lies between the outer wall and the airborne sound absorber. As a result of the cavity, there is no contact between the thin-walled wall section and the airborne sound absorber within the depression, as a result of which the vibration capability of the thin-walled wall section is not impaired. An efficient discharge of airborne sound from the interior into the surrounding area or into the airborne sound absorber can therefore be realised.

In another embodiment, on the outer side of the outer wall, the airborne sound absorber can cover an outer wall region which comprises the thin-walled wall section. This means that the airborne sound absorber covers the outer wall region which is larger than the thin-walled wall section which is contained therein. It can also be provided, in particular, that two or more thin-walled wall sections of the outer wall can be covered by way of a single, common airborne sound absorber.

In another advantageous embodiment, the wall thickness in the thin-walled wall section can be at most 75% of the wall thickness which is present in the outer wall outside the thin-walled wall section. It is likewise conceivable that the wall thickness in the thin-walled wall section is limited to at most 50% of the wall thickness outside the thin-walled wall section. The wall thickness in the thin-walled wall section is preferably approximately 50% of the wall thickness which is present in the outer wall outside the thin-walled wall section. It is likewise conceivable to select the wall thickness in the thin-walled wall section to be less than 50% of the wall thickness outside the thin-walled wall section. Furthermore, it is conceivable to provide the wall thickness in the thin-walled region with a minimum wall thickness which can be, for example, at least 10% or at least 20% or at least 25% of the wall thickness which is present outside the thin-walled wall section. One embodiment is particularly advantageous, in which the wall thickness in the thin-walled region lies in a range from 25% to 75%, preferably in a range from 30% to 70% and, in particular, in a range from 40% to 60% of that wall thickness which is present in the outer wall outside the thin-walled wall section.

According to one advantageous embodiment, the airborne sound absorber can be formed by way of an open-pored foam body. The said foam body can have a skin on its outer side which faces away from the outer wall. A skin of this type on the outer side of the foam body produces a closed-pored structure on the outer side of the foam body and brings about a reflection of airborne sound in the interior of the foam body, which improves the sound damping action. The foam body is of open-pored configuration at least on its inner side which faces the outer wall, that is to say is without a skin of this type.

In principle, the foam body can be foamed onto the outer wall. One embodiment is preferred, however, in which the foam body is attached to the outer wall in the form of a separate component.

The airborne sound absorber which represents a separate component with regard to the outer wall is attached to the outer wall in a suitable way. The airborne sound absorber is preferably clipped to the outer wall. As an alternative, hooks can also be provided, in order to fix the airborne sound absorber on the outer wall. Furthermore, it is conceivable to adhesively bond the airborne sound absorber to the outer wall.

In another advantageous embodiment, at least one housing region of this type, through which flow can pass, can be formed by way of a chamber, through which the air flow can flow in the housing. For example, the said chamber can accommodate a fan impeller and can be divided by way of the fan impeller into a suction side and a pressure side.

In addition or as an alternative, at least one housing region of this type, through which flow can pass, can be formed by way of a channel which serves in the housing for guiding the air flow. A channel of this type can be arranged in the housing on the suction side of the fan and can contain, for example, an air filter. A channel of this type can also be arranged on the pressure side of the fan, however, and can contain, for example, at least one heating element for heating the air flow and/or at least one cooling element for cooling the air flow.

The depression which was mentioned further above can then preferably extend transversely with respect to a longitudinal direction of the channel. As a result, the available installation space on the outer side of the channel can be utilized in an optimum manner, in order to damp as much disruptive noise as possible. The longitudinal direction of the channel is defined by the direction in which the channel guides the air flow, and as a rule runs parallel to the longitudinal centre axis of the channel.

The depression can advantageously extend over the entire width of the channel, which width runs transversely with respect to the longitudinal direction of the channel. As a result, the available installation space on the outer side of the channel is utilized to a maximum extent.

At least one heating element, through which the air flow can flow, can expediently be arranged in the housing. In addition or as an alternative, at least one cooling element, through which the air flow can flow, can be arranged in the housing. In addition or as an alternative, at least one filter element, through which the air flow can flow, can be arranged in the housing. Therefore, the air flow can be filtered and/or heated and/or cooled during operation of the air conditioning unit.

Further important features and advantages of the invention result from the subclaims, from the drawings and from the associated description of the figures using the drawings.

It goes without saying that the features which are mentioned above and which are still to be explained in the following text can be used not only in the respectively specified combination, but rather also in other combinations or on their own, without departing from the scope of the present invention.

Preferred exemplary embodiments of the invention are shown in the drawings and will be explained in greater detail in the following description, identical reference numerals relating to identical or similar or functionally identical components.

### BRIEF DESCRIPTION OF THE DRAWINGS

In the drawings, in each case diagrammatically,

FIG. 1 shows a greatly simplified, circuit diagram-like longitudinal section of an air conditioning unit,

FIG. 2 shows a simplified cross section of the air conditioning unit in accordance with sectional lines II in FIG. 1,

FIG. 3 shows a simplified longitudinal section of the air conditioning unit in accordance with sectional lines III in FIG. 2, and

FIG. 4 shows a side view of the air conditioning unit in accordance with a viewing direction IV in FIG. 2.

### DETAILED DESCRIPTION

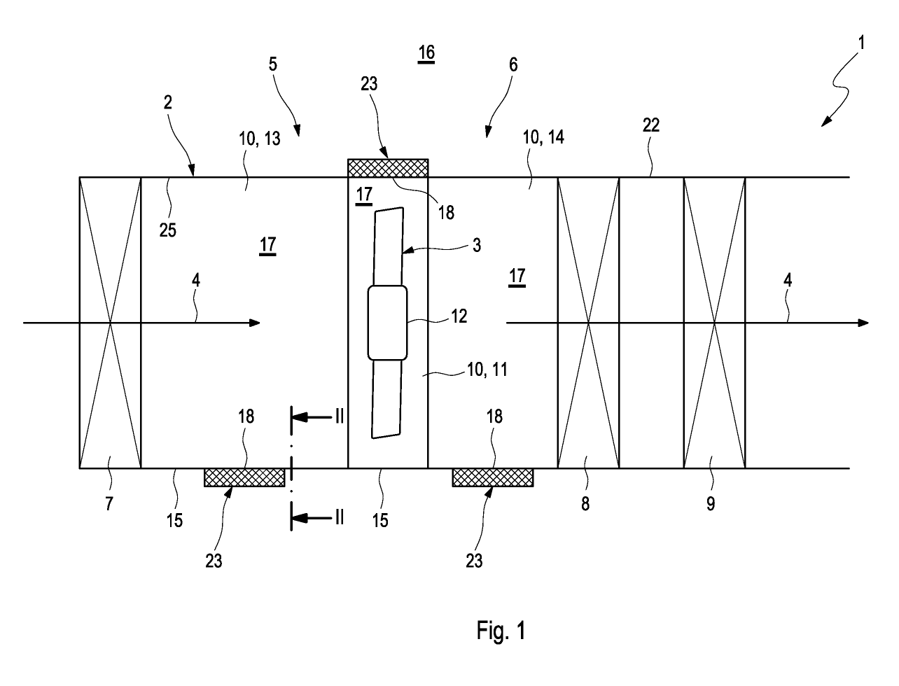

In accordance with FIG. 1, an air conditioning unit 1 which is suitable for use in a motor vehicle comprises a housing 2, in which a fan 3 is arranged for generating an air flow 4. The air flow 4 is indicated by way of arrows in FIG. 1 and is present only when the fan 3 is in operation. The fan 3 can in principle be as desired. FIG. 1 shows the fan 3 as an axial fan. However, a fan 3 which is configured as a radial fan is usually used in an air conditioning unit 1. The fan 3 divides the housing 2 into a suction side 5 of the housing 2, which suction side 5 is present upstream of the fan 3, and a pressure side 6 of the housing 2, which pressure side 6 is present downstream of the fan 3. Moreover, the air conditioning unit 1 has a filter body 7 in the housing 2 on the suction side 5, through which filter body 7 the air flow 4 can flow, and which filter body 7 serves for cleaning the air flow 4. Moreover, at least one cooling element 8 for cooling the air flow 4 and at least one heating element 9 for heating the air flow 4 are arranged in the housing 2 on the pressure side 6. The air flow 4 can flow in each case through cooling elements 8 and heating elements 9. It is clear, moreover, that the air conditioning unit 1 has suitable control means in the housing 2, in particular flaps, slides and the like which are omitted here, however, in order to simplify the illustration. Control means of this type are provided for controlling the guidance of the air flow 4 within the housing 2, in particular for flowing through or bypassing the heating element 9, and/or for distributing the air flow 4 to different outlet channels (not shown here), through which the air-conditioned air flow 4 is fed to a vehicle interior compartment. The air conditioning unit 1 serves to air-condition a vehicle interior compartment of a vehicle which is equipped with the air conditioning unit 1. To this end, the air conditioning unit air-conditions the air flow 4 which is ultimately fed to the said vehicle interior space via outlet channels (not shown here).

The housing 2 has at least one housing region 10, through which the air flow 4 can flow. The said housing regions 10, through which flow can pass or through which flow passes, are of course flowed through by the air flow 4 only during the operation of the fan 3, with the result that the term “flowed through” is always to be understood in the present context as meaning that there is said throughflow when the fan 3 is switched on.

In the example of FIG. 1, three housing regions 10, through which flow can pass, of this type are indicated purely by way of example, namely a housing region 10 which is arranged directly in the region of the fan 3, a housing region 10 which is arranged on the suction side of the fan 3, and a housing region 10 which is arranged on the pressure side of the fan 3. The housing region 10 which is arranged in the region of the fan 3 is, for example, a chamber 11, in which a fan impeller 12 of the fan 3 is arranged. The suction-side housing region 10 is, for example, a suction-side channel 13 which guides the air flow 4 in the direction of the fan 3. In the example of FIG. 1, the filter element 7 is arranged in the said suction-side channel 13. In the example of FIG. 1, the housing region 10 which is arranged on the pressure side is a pressure-side channel 14 which guides the air flow 4 downstream of the fan 3. In the example, the pressure-side channel 14 guides the air flow 4 away from the fan 3. Furthermore, in the example, the pressure-side channel 14 contains the cooling element 8 and the heating element 9. At least in the said housing regions 10, through which flow passes, the housing 2 in each case has an outer wall 15 which separates a surrounding area 16 of the housing 2 from an interior 17 of the respective housing region 10. The said interior 17 forms the zone of the respective housing region 10, through which flow passes, through which zone the air flow 4 can flow.

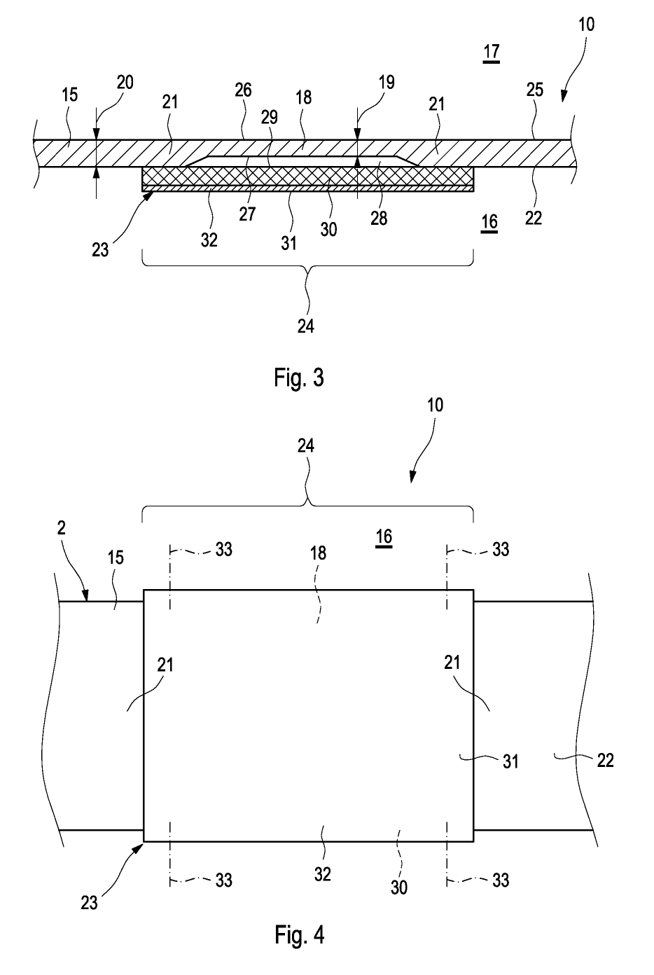

In accordance with FIGS. 1 to 4, a wall section 18 of the outer wall 15 is of thin-walled configuration in the case of the respective region 10, through which flow passes. As a result, a wall thickness 19 of the outer wall 15 in the said thin-walled wall section 18 according to FIG. 3 is smaller than a wall thickness 20 of the outer wall 15, which wall thickness 20 the outer wall 15 has outside the thin-walled wall section 18. Here, the larger or normal wall thickness 20 is present at least in a wall section 21 which adjoins the thin-walled wall section 18 and, in particular, encloses the latter. As can be seen, the wall thickness 19 in the thin-walled wall section 18 is approximately half as great as the wall thickness 20 outside the thin-walled wall section 18. The wall thickness 19 of the thin-walled wall section 18 expediently lies in a range from approximately 25% to approximately 75% of the wall thickness 20 which is present in the outer wall 15 outside the thin-walled wall section 18, but at least in the adjoining wall section 21.

As can be gathered, furthermore, from FIGS. 1 to 4, an airborne sound absorber 23 is arranged on the outer wall 15 in the respective housing region 10 on an outer side 22 of the outer wall 15, which outer wall 22 faces away from the interior 17. Here, the respective airborne sound absorber 23 is arranged on the outer wall 15 on the outer side 22 in each case in the region of the respective thin-walled wall section 18.

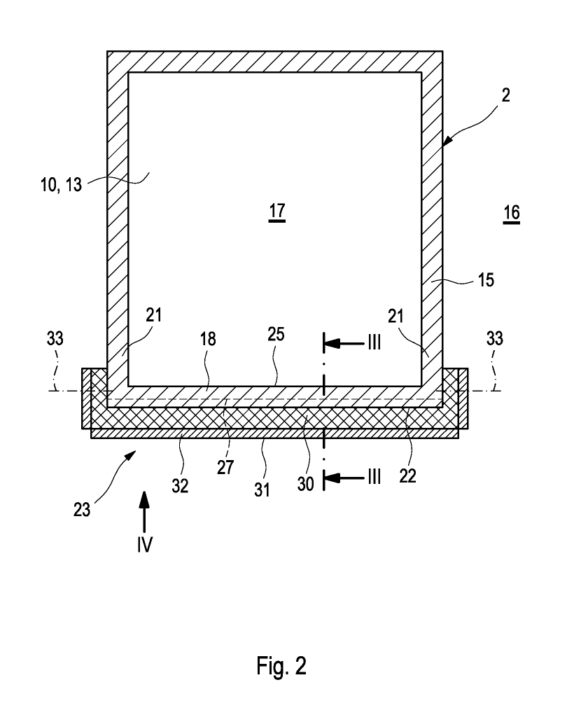

Although FIGS. 2 to 4 according to the sectional lines II in FIG. 1 relate only to the suction-side housing region 10 which is formed by way of a suction-side channel 13, the explanations which are made with respect to FIGS. 2 to 4 likewise apply to the housing region 10 which is configured as a chamber 11, to the housing region 10 which is configured as a pressure-side channel 14, and to every other housing region 10 which is not mentioned explicitly here, through which the air flow 4 can flow, and which can be provided with a thin-walled wall section 18 and with an airborne sound absorber 23.

According to FIG. 3, the outer wall 15 is continuously configured from one material in order to configure the thin-walled wall section 18, with the result that the thin-walled wall section 18 forms an integral constituent part of the remaining outer wall 15. This applies at least to an outer wall region 24 which contains the thin-walled wall section 18 and the adjoining wall section 21.

Furthermore, it can be gathered from FIG. 3 that the outer wall 15 in the said outer wall region 24 is of continuous configuration on an inner side 25 of the outer wall 15, which inner side 25 faces the interior 17. In other words, in the said outer wall region 24, the outer wall 15 has a constant, continuous, stepless contour 26 on its inner side 25. The uniform contour 26 brings it about that the thin-walled wall section 18 cannot be identified from the interior 17, that is to say does not differ from the adjoining wall section 21. No transition can likewise be detected on the inner side 25 between the thin-walled wall section 18 and the adjoining wall section 21. It is clear that production-induced dimensional deviations can occur which are produced, for example, by way of distortion during cooling if the housing 2 is injection moulded from plastic and the wall sections 18, 25 are realised here with different wall thicknesses 19, 20.

According to FIG. 3, it is provided in order to realise the thin-walled wall section 18 that a depression 27 is provided in the outer wall 15 exclusively on the outer side 22 of the outer wall 15. The wall thickness 19, 20 of the outer wall 15 is reduced by way of the said depression 27, without the contour 26 on the inner side 25 being changed here. In FIG. 2, the depression 27 is indicated by way of an interrupted line.

As can be seen, the depression 27 can extend transversely with respect to a longitudinal direction of the respective housing region 10 which is configured as a channel 13, 14. The longitudinal direction of the channel 13, 14 is defined by the direction in which the channel 13, 14 guides the air flow 4 which is shown in FIG. 1. The channel longitudinal direction runs as a rule parallel to the longitudinal centre axis of the channel 13, 14. The channel 13, 14 can preferably be rectilinear in the region of the depression 27. In FIG. 2, the longitudinal direction or the longitudinal centre axis of the channel 13, 14 lies perpendicularly on the plane of the drawing. As shown in FIG. 2, the depression 27 can advantageously extend over the entire width of the channel 13, 14, which width runs transversely with respect to the longitudinal direction of the channel 13, 14.

According to FIG. 3, the depression 27 forms a cavity 28 which lies between the outer wall 15 and the airborne sound absorber 23. In particular, the cavity 28 is arranged between an inner side 29 of the airborne sound absorber 23, which inner side 29 faces the outer wall 15, and the outer side 22 of the outer wall 15 in the thin-walled wall section 18. Here, the cavity 28 is not filled or is not filled completely by the airborne sound absorber 23. As an alternative to this, the airborne sound absorber 23 can also be formed in such a way that it fills the said depression 27 completely or only partially.

The airborne sound absorber 23 is expediently of greater dimensions than the thin-walled wall section 18. In the example of FIG. 3, the airborne sound absorber 23 is dimensioned in such a way that it covers the outer wall region 24, that is to say also the adjoining wall section 21 in addition to the thin-walled wall section 18.

The airborne sound absorber 23 is expediently formed by way of an open-pored foam body 30. Conceivable foams are, for example, PU, PUR, PP, PE, EPP and PEPP. One embodiment is advantageous, in which the foam body 30 has a skin 32 on an outer side 31 of the airborne sound absorber 23, which outer side 31 faces away from the outer wall 15. As a result of the said skin 32, the foam body 30 which is open-pored per se has a closed-pored structure or skin on the outer side 31 of the airborne sound absorber 23.

The airborne sound absorber 23 can be connected fixedly to the outer wall 15 in a suitable way. It is conceivable to foam the foam body 30 onto the outer wall 15. A constructive embodiment is preferred, however, in which the airborne sound absorber 23 is a separate component with regard to the outer wall 15 and is attached to the outer wall 15. For example, the airborne sound absorber 23 can be adhesively bonded to the outer wall 15. Fastening means 33 which are indicated in FIGS. 2 and 4 by way of interrupted lines can likewise be used. Suitable fastening means 33 are, for example, hooks which are attached on the outer wall 15 and on which the airborne sound absorber 23 is hooked. The fastening means 33 can likewise be clip connections or latching connections, by way of which the airborne sound absorber 23 is fixed on the housing 15 by latching or clipping. Fixing of the airborne sound absorber 23 by means of a hook and loop fastener is likewise conceivable.

1. An air conditioning unit for a motor vehicle, comprising:
a housing, including a fan arranged within the housing for generating an air flow and at least one housing region through which the air flow is flowable; and
an outer wall of the housing separating a surrounding region of the housing from an interior of the at least one housing region, the air flow being flowable through the interior;
wherein the outer wall has at least one wall section in which a wall thickness of the outer wall is smaller than a wall thickness of the outer wall outside the wall section; and
wherein an airborne sound absorber is arranged on an outer side of the outer wall in a region of the wall section, the outer side of the outer wall facing away from the interior.

2. The air conditioning unit according to claim 1, wherein the outer wall is of continuous configuration in an outer wall region (24) that contains the wall section.

3. The air conditioning unit according to claim 1, wherein:
the outer wall includes an outer wall region containing the wall section;
the outer wall includes an inner side facing the interior; and
the inner side of the outer wall is of continuous configuration in the outer wall region.

4. The air conditioning unit according to claim 1, wherein the outer wall is configured from one material in an outer wall region that includes the wall section and an adjoining wall section.

5. The air conditioning unit according to claim 1, wherein the wall section is formed by way of a depression in the outer wall, the depression configured only on the outer side of the outer wall.

6. The air conditioning unit according to claim 5, wherein the airborne sound absorber fills the depression.

7. The air conditioning unit according to claim 5, wherein the depression forms a cavity between the outer wall and the airborne sound absorber.

8. The air conditioning unit according to claim 1, wherein the airborne sound absorber covers an outer wall region, the outer wall region including the wall section.

9. The air conditioning unit according to claim 1, wherein the wall thickness of the outer wall in the wall section is at most 75% of the wall thickness of the outer wall outside the wall section.

10. The air conditioning unit according to claim 1, wherein the airborne sound absorber is formed by way of an open-pored foam body.

11. The air conditioning unit according to claim 10, wherein the open-pored foam body includes an outer side that faces away from the outer wall, the outer side having a skin.

12. The air conditioning unit according to claim 1, wherein the airborne sound absorber is clipped to the outer wall.

13. The air conditioning unit according to claim 1, wherein the at least one housing region is a chamber through which the air flow is flowable.

14. The air conditioning unit according to claim 1, wherein the at least one housing region is a channel for guiding the air flow.

15. The air conditioning unit according to claim 14, wherein the wall section is formed by way of a depression in the outer wall, the depression configured only on the outer side of the outer wall and extends transversely with respect to a longitudinal direction of the channel.

16. The air conditioning unit according to claim 15, wherein the depression extends over an entire width of the channel, the width of the channel running transversely to the longitudinal direction of the channel.

17. The air conditioning unit according to claim 1, wherein at least one heating element is arranged in the housing, the air flow being flowable through the at least one heating element.

18. The air conditioning unit according to claim 1, wherein at least one cooling element is arranged in the housing, the air flow being flowable through the at least one cooling element.

19. The air conditioning unit according to claim 1, wherein at least one filter element is arranged in the housing, the air flow being flowable through the at least one filter element.

20. An air conditioning unit for a motor vehicle, comprising:
a housing, including a fan arranged within the housing for generating an air flow and at least one housing region through which the air flow is flowable;
an airborne sound absorber; and
an outer wall of the housing separating a surrounding region of the housing from an interior of the at least one housing region, the air flow being flowable through the interior, the outer wall having:
an outer side that faces away from the interior;
an inner side that faces the interior;
at least one wall section in which a wall thickness of the outer wall is smaller than a wall thickness of the outer wall outside the at least one wall section; and
an outer wall region containing the wall section;
wherein the airborne sound absorber is arranged on the outer side of the outer wall in a region of the at least one wall section;
wherein the inner side of the outer wall is of continuous configuration in the outer wall region; and
wherein the wall section is formed by way of a depression in the outer wall, the depression configured only on the outer side of the outer wall.
